(19) United States
(12) Patent Application Publication
(10) Pub. No.: US 2026/0122162 A1
(43) Pub. Date: Apr. 30, 2026

(54) HINGE HAVING BOTH FRICTION ROTATION SHAFT AND AUTOMATIC POP-OPEN FUNCTIONS

(71) Applicant: Hangzhou Amphenol Phoenix Telecom Parts Co., Ltd., Hangzhou, Zhejiang (CN)

(72) Inventors: Jingjiang ZHANG, Hangzhou, Zhejiang (CN); Zike HU, Hangzhou, Zhejiang (CN); Xianchao LI, Hangzhou, Zhejiang (CN)

(21) Appl. No.: 19/149,295

(22) PCT Filed: Jan. 8, 2024
(86) PCT No.: PCT/CN2024/071093

§ 371 Date: Jul. 18, 2025

(30) Foreign Application Priority Data
Jan. 19, 2023 (CN) 202310097092.9

(51) Int. Cl. H04M 1/02; G06F 1/16

(52) U.S. Cl. CPC H04M 1/0216; G06F 1/1681; G06F 1/1652; H04M 1/0268

(57) ABSTRACT

A hinge having both friction rotation shaft and automatic pop-open functions includes a left-side rotating connection member, a right-side rotating connection member, and a plurality of matched rotation friction matching pieces and fixed friction matching pieces. The hinge is further provided with clutch cams, pop-open cams, a clutch member and a spring assembly. The present invention can switch between the friction rotation shaft function and the automatic pop-open function according to requirements, thus providing a high friction resistance torque within a design angle range so as to obtain a required operation feedback or achieve a free stop function, and also achieving the automatic pop-open or/and closing function at a required angle position, with the two functions not interfering with each other.

### FIELD OF THE INVENTION

The present invention relates to hinges applied to mobile terminals such as mobile phones and laptop computers, particularly to flexible screen mobile terminals, and more particularly to inward-folding flexible screen mobile terminals.

### BACKGROUND OF THE INVENTION

Mobile terminals, such as inward-folding flexible screen mobile terminals, generally include a left housing and a right housing, with a flexible screen arranged on the inner side. The left side of the flexible screen is connected to the left housing, and the right side thereof is connected to the right housing. A friction structure, also known as a friction rotation shaft structure, is often provided to increase the resistance torque when the housing is rotated to open or close, so as to obtain operational feedback or achieve a free-stopping function. However, this structural function is difficult to be compatible with an automatic pop-open function, such as requiring automatic pop-open to flatten when manually unfolded to nearly flattened, but the high friction torque generated by the aforesaid friction structure will cause the automatic pop-open function to fail. Alternatively, in order to ensure the automatic pop-open function, it is difficult for the friction torque to reach the ideal requirement, thereby affecting the function.

### SUMMARY OF THE INVENTION

It is an object of the present invention to provide a hinge having both friction rotation shaft and automatic pop-open functions, which can be applied to a mobile terminal and is capable of achieving a high friction resistance torque while providing an automatic pop-open function. For this purpose, the present invention adopts the following technical solutions: A hinge having both friction rotation shaft and automatic pop-open functions comprises a left-side rotating connection member, a right-side rotating connection member, and a plurality of matched rotation friction matching pieces and a plurality of fixed friction matching pieces, wherein the rotation friction matching pieces comprise a plurality of left-side rotation friction matching pieces and a plurality of right-side rotation friction matching pieces, the left-side rotation friction matching pieces are slidably connected to the left-side rotating connection member such that the left-side rotation friction matching pieces rotate synchronously with the left-side rotating connection member but can slide axially relative to the left-side rotating connection member, the right-side rotation friction matching pieces are slidably connected to the right-side rotating connection member such that the right-side rotation friction matching pieces rotate synchronously with the right-side rotating connection member but can slide axially relative to the right-side rotating connection member;
the hinge is provided with clutch cams, pop-open cams, a clutch member, and a spring assembly, both the pop-open cams and the clutch cams comprise static cams and rotating cams, the rotating cams can rotate relative to the static cams, wherein the rotating cams of the pop-open cams are connected to the left-side rotating connection member or the right-side rotating connection member, the rotating cams of the pop-open cams are slidably connected to the left-side rotating connection member or the right-side rotating connection member, and rotate synchronously with the connected left-side rotating connection member or right-side rotating connection member but can be displaced axially relative thereto; the hinge has a first working state and a second working state in the rotation stroke of the left-side rotating connection member and the right-side rotating connection member; in the first working state, the spring assembly provides a high rotational torque by pressing the matching of clutch cams through the clutch member and the clutch cams and pressing the friction matching between left-side rotation friction matching pieces and fixed friction matching pieces and between the right-side rotation friction matching pieces and the fixed friction matching pieces; in the second working state, the clutch member is disengaged from the spring assembly, the spring assembly maintains an axial pressing force on the left-side rotating connection member and the right-side rotating connection member, the rotation friction matching pieces and the fixed friction matching pieces are loosened, the rotating cams and the static cams of the pop-open cams realize an automatic rotation function by means of the pressing of the spring assembly and the control of the pop-open cams;
the clutch cams control the clutch member, in the first working state, the clutch cams enter a high-position matching, so that the clutch member moves axially forward and then axially abuts against the spring assembly, the spring assembly presses the clutch cams and the rotation friction matching pieces and the fixed friction matching pieces through the clutch member; in the second working state, clutch cams enter a low-position matching, so that there is a gap between the clutch member and the spring assembly in the axial direction, and the rotation friction matching pieces and the fixed friction matching pieces are loosened.

The present invention may further adopt the following technical solutions based on the aforementioned technical solutions, or use these further technical solutions in combination:
the hinge comprises a left-side rotating connection member shaft and a right-side rotating connection member shaft in parallel, the left-side rotating connection member shaft passes through the left-side rotation friction matching pieces and left sides of the fixed friction matching pieces, the right-side rotating connection member shaft passes through the right-side rotation friction matching pieces and right sides of the fixed friction matching pieces; the clutch cams are located between the rotation friction matching pieces and the spring assembly; the clutch cams comprise left-side clutch cams and right-side clutch cams, the rotating cams of the left-side clutch cams are slidably connected to the left-side rotating connection member, the rotating cams of the right-side clutch cams are slidably connected to the right-side rotating connection member, the left-side rotating connection member shaft and the right-side rotating connection member shaft pass through the left-side clutch cams and the right-side clutch cams respectively, the static cams of the left-side clutch cams and right-side clutch cams are connected together; the pop-open cams are located on the other side of the rotation friction matching pieces, and the pop-open cams comprise the left-side pop-open cams and right-side pop-open cams, the rotating cams of the left-side pop-open cams are connected to the left-side rotating connection member, the rotating cams of the right-side pop-open cams are connected to the right-side rotating connection member, the left-side rotating connection member shaft and the right-side rotating connection member shaft pass through the left-side pop-open cams and the right-side pop-open cams respectively, and the static cams of the left-side pop-open cams and the right-side pop-open cams are connected together.

The clutch member is connected to static cams of the clutch cams, the static cams of the clutch cams cannot rotate but can be axially displaced.

Rotation friction matching pieces are also provided on the back of the rotating cams of the clutch cams.

The pop-open cams have a descending matching from a high-position matching to a low-position matching in the second working state, and a high-position platform matching in the first working state.

The left-side rotating connection member and the right-side rotating connection member are connected by a synchronous reverse rotating connection member to rotate synchronously and reversely; the left-side rotation friction matching pieces and the right-side rotation friction matching pieces are also connected to the left-side rotating member and the right-side rotating member of the synchronous reverse rotating connection mechanism.

The spring assembly is axially adjacent to the left-side rotating connection member and the right-side rotating connection member, and in the second working state, directly acts on the left-side rotating connection member and the right-side rotating connection member.

The spring assembly comprises a plurality of springs, a spring base and a spring bracket that can move forward and backward, the plurality of springs are located between the spring base and the spring bracket, both the left-side rotating connection member shaft and the right-side rotating connection member shaft pass through the spring base and the spring bracket, and the clutch member abuts against the spring bracket.

The left-side rotation friction matching pieces, the right-side rotation friction matching pieces and the rotating cams of the clutch cams are respectively provided with a handle portion, and are slidably clamped on the left-side rotating connection member or the right-side rotating connection member through the handle portion.

The hinge is a hinge of a mobile terminal, for example, a hinge of an inward-folding flexible screen mobile terminal.

The second working state corresponds to a rotation angle range of a mobile terminal from nearly unfolding and flattening to unfolding and flattening, or a rotation angle range of a mobile terminal from nearly folding to folding, or corresponds to two rotation angle ranges.

By virtue of the technical solutions adopted in the present invention, the present invention can switch between the friction rotation shaft function and the automatic pop-open function according to requirements, thus providing a high friction resistance torque within a design angle range so as to obtain a required operation feedback or achieve a free stop function, and also achieving the automatic pop-open or/and closing function at a required angle position, with the two functions not interfering with each other.

### BRIEF DESCRIPTION OF THE DRAWINGS

FIG. 1 is an exploded structural view of an embodiment of the present invention.

FIG. 2 and FIG. 3 are respectively a top view and a front view of an embodiment of the present invention corresponding to a folded state of a mobile terminal.

FIG. 4 and FIG. 5 are respectively a top view and a front view of an embodiment of the present invention corresponding to a mobile terminal being unfolded or folded to a certain angle.

FIG. 6 and FIG. 7 are respectively a top view and a front view of an embodiment of the present invention corresponding to a mobile terminal being unfolded and flattened.

FIG. 8 is a schematic diagram illustrating the matching in the first working state of an embodiment of the present invention.

FIG. 9 is a schematic diagram illustrating the matching in the second working state of an embodiment of the present invention.

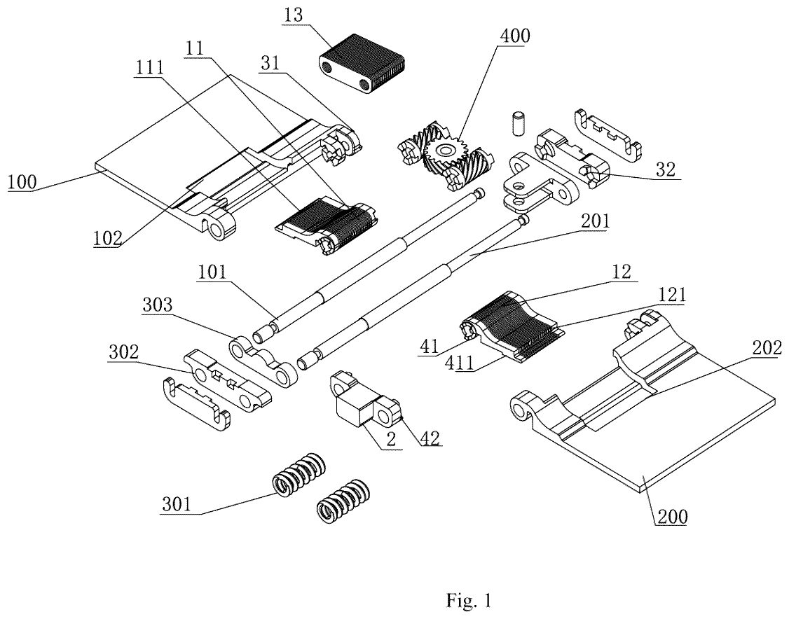

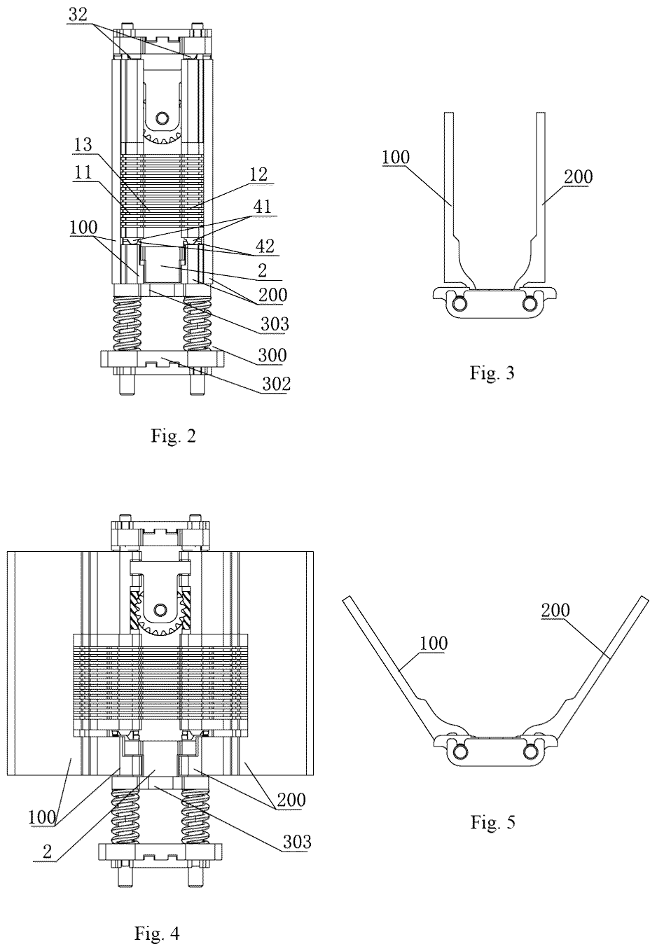

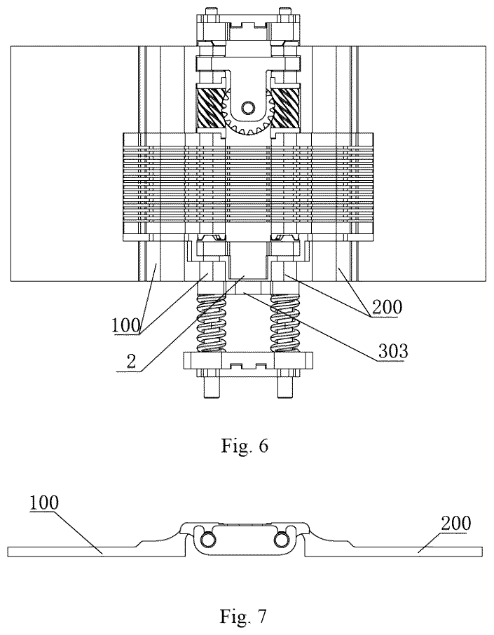

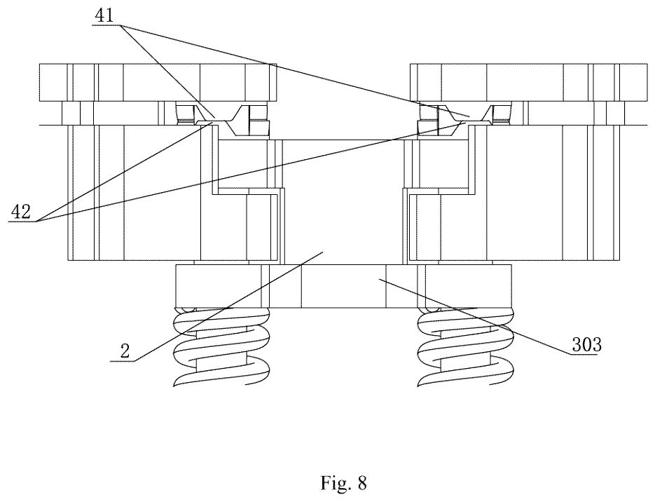

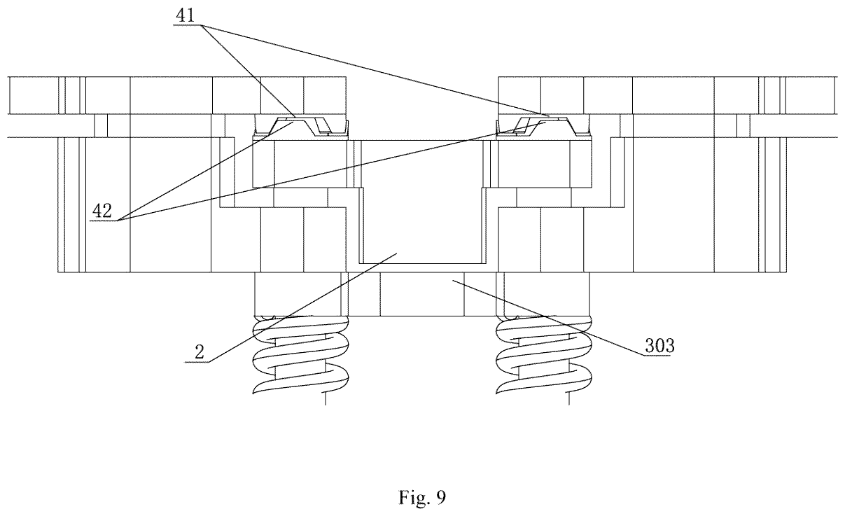

### DETAILED DESCRIPTION

Referring to the figures, this embodiment uses an application in an inward-folding flexible screen mobile terminal as an example. The hinge having both friction rotation shaft and automatic pop-open function comprises a left-side rotating connection member 100, a right-side rotating connection member 200, and a plurality of matched rotation friction matching pieces and a plurality of fixed friction matching pieces 13. The left-side rotating connection member 100 and the right-side rotating connection member 200 can be connected to the left-side housing and the right-side housing of the inward-folding flexible screen mobile terminal respectively, or connected to components in the hinge that are connected to the left housing and the right housing.

The rotation friction matching pieces comprises a plurality of left-side rotation friction matching pieces 11 and a plurality of right-side rotation friction matching pieces 12, the left-side rotation friction matching pieces 11 are slidably connected to the left-side rotating connection member 100 such that the left-side rotation friction matching pieces 11 rotate synchronously with the left-side rotating connection member 100 but can slide axially relative to the left-side rotating connection member 100, the right-side rotation friction matching pieces 12 are slidably connected to the right-side rotating connection member 200 such that the right-side rotation friction matching pieces 12 rotate synchronously with the right-side rotating connection member 200 but can slide axially relative to the right-side rotating connection member 200. This slippage is relatively small, so as to reduce the requirements on the cams and make the mechanism switching more sensitive. It only needs to ensure that the rotation friction matching pieces and the fixed friction matching pieces can be pressed through a small amount of slip in the first working state described below, and can be loosened in the second working state. At the same time, by virtue of this pressing, in the first working state, the left-side rotating connection member 100 and the right-side rotating connection member 200 can also be pressed through this transmission route, thereby pressing the pop-open cams. A set of shared spring assembly can operate in two working states and achieve forward and reverse switching.

The hinge is provided with clutch cams, pop-open cams, a clutch member 2, and a spring assembly 300, both the pop-open cams and the clutch cams comprise static cams and rotating cams, the rotating cams can rotate relative to the static cams.

The pop-open cams comprise the left-side pop-open cams and right-side pop-open cams, the rotating cams 31 of the left-side pop-open cams are connected to the left-side rotating connection member 100, the rotating cams 31 of the right-side pop-open cams are connected to the right-side rotating connection member 200.

The clutch cams comprise left-side clutch cams and right-side clutch cams. The rotating cams 41 of the left-side clutch cams are slidably connected to the left-side rotating connection member 100, and rotate synchronously with the connected left-side rotating connection member 100 but can be displaced axially relative thereto, the rotating cams 41 of the right-side clutch cams are slidably connected to the right-side rotating connection member 200, and rotate synchronously with the connected right-side rotating connection member 200 but can be displaced axially relative thereto.

The hinge has a first working state and a second working state in the rotation stroke of the left-side rotating connection member 100 and the right-side rotating connection member 200. In the first working state, the spring assembly 300 provides a high rotational torque by pressing the matching of clutch cams through the clutch member 2 and the clutch cams and pressing the friction matching between left-side rotation friction matching pieces 11 and fixed friction matching pieces 13 and between the right-side rotation friction matching pieces 12 and the fixed friction matching pieces 13, so as to realize a free parking function, that is, during the rotation process, once the external force is removed, the spring assembly stays at the current rotation angle. In the second working state, the clutch member 2 is disengaged from the spring assembly, the spring assembly 300 maintains an axial pressing force on the left-side rotating connection member 100 and the right-side rotating connection member 200, the rotation friction matching pieces and the fixed friction matching pieces are loosened, the rotating cams 31 and the static cams of the pop-open cams realize an automatic rotation function by means of the pressing of the spring assembly 300 and the control of the pop-open cams. In this embodiment, the second working state corresponds to a rotation angle range of a mobile terminal from nearly unfolding and flattening to unfolding and flattening.

The clutch cams control the clutch member 2, in the first working state, the clutch cams enter a high-position matching (for example, top-to-top matching), so that the clutch member 2 moves axially forward and then axially abuts against the spring assembly 300, the spring assembly presses the clutch cams and the rotation friction matching pieces and the fixed friction matching pieces through the clutch member 2; in the second working state, clutch cams enter a low-position matching (for example, top-to-bottom matching), so that there is a gap between the clutch member 2 and the spring assembly 300 in the axial direction, and the rotation friction matching pieces and the fixed friction matching pieces are loosened.

The hinge comprises a left-side rotating connection member shaft 101 and a right-side rotating connection member shaft 201 in parallel, the left-side rotating connection member shaft 101 passes through the left-side clutch cams, the left-side rotation friction matching pieces 11, left sides of the fixed friction matching pieces, and the left-side pop-open cams. The right-side rotating connection member shaft 201 passes through the right-side clutch cams, the right-side rotation friction matching pieces 12, right sides of the fixed friction matching pieces, and the right-side pop-open cams.

The clutch cams are located between the rotation friction matching pieces and the spring assembly 300; the static cams 42 of the left-side clutch cams and right-side clutch cams are connected together. The pop-open cams are located on the other side of the rotation friction matching pieces; the static cams 32 of the left-side pop-open cams and the right-side pop-open cams are connected together.

The clutch member 2 and the static cams 42 of the clutch cams are preferably integrated into a single unit, which not only reduces the number of parts but also improves the sensitivity. The static cams 42 of the clutch cams are cams that are non-rotatable yet axially displaceable.

Rotation friction matching pieces are also provided on the back of the rotating cams 41 of the clutch cams.

In the second working state, the pop-open cams transition from a high-position matching to a low-position matching (for example, from a top-to-top matching to an inclined segment matching of top-to-bottom matching); in the first working state, pop-open cams maintain a high-position platform matching (for example, the tops of the rotating cams 31 and the static cams 32 of the pop-open cams are both platforms or one of them is a platform and the other is a convex end).

The left-side rotating connection member 100 and the right-side rotating connection member 200 are connected by a synchronous reverse rotating connection member 400 to rotate synchronously and reversely; the synchronous reverse rotating connection mechanism 400 may be any one of various synchronous reverse rotating connection mechanisms used in flexible screen mobile terminals, and the connection method may also be fixed connection, keyway matching connection, etc. Preferably, the left-side rotation friction matching pieces and the right-side rotation friction matching pieces are also connected to the left-side rotating member and the right-side rotating member of the synchronous reverse rotating connection mechanism (for example, the left gear and the right gear are connected) to obtain stronger integrity.

The spring assembly 300 is axially adjacent to the left-side rotating connection member 100 and the right-side rotating connection member 200, and in the second working state, directly acts on the left-side rotating connection member 100 and the right-side rotating connection member 200. At this time, the clutch cams are in a low position and the axial length thereof is insufficient to support the clutch member 2 abutting against the spring assembly 300, resulting in an axial gap between the clutch member 2 and the spring assembly. Consequently, the left-side rotating connection member 100 and the right-side rotating connection member 200 abut against the spring assembly 300 instead of the clutch member 2. Certainly, gaskets can be provided between the spring assembly 300 and the left-side rotating connection member 100 and the right-side rotating connection member 200.

The spring assembly comprises a plurality of springs 301, a spring base 302 and a spring bracket 303 that can move forward and backward, the plurality of springs 301 are located between the spring base 302 and the spring bracket 303, both the left-side rotating connection member shaft 101 and the right-side rotating connection member shaft 201 pass through the spring base 302 and the spring bracket 303, and the clutch member 2 abuts against the spring bracket 303.

The left-side rotation friction matching pieces 11, the right-side rotation friction matching pieces 12 and the rotating cams 41 of the clutch cams are respectively provided with a handle portion 111, 121, 411, and are slidably clamped on the left-side rotating connection member 100 or the right-side rotating connection member 200 through the handle portion. The left-side rotating connection member 100 and the right-side rotating connection member 200 may be provided with matching slots 102, 202.

The foregoing description only describes the specific embodiments of the present invention, but the structural features of the present invention are not limited thereto. Any changes or modifications made by those skilled in the art within the field of the present invention shall fall within the scope of protection of the present invention.

It should be noted that the terms “comprising” and “having” in the description and claims of the present invention and the accompanying drawings, as well as any modifications thereof, are intended to cover non-exclusive inclusion. The terms “installed/mounted”, “arranged”, “set”, “connected”, “sleeved” should be construed broadly. For example, it may be a fixed connection, a detachable connection, or an integral structure; it may be a mechanical connection, or an electrical connection; it may be directly connected, or indirectly connected through an intermediary, or between two devices, elements, or internal communication between components. For those of ordinary skill in the art, the specific meanings of the above terms in the present invention can be understood according to specific situations.

It should be understood that, in the description of the present invention, the orientation or positional relationship indicated by the terms “one end”, “another end”, “outside”, “inside”, “horizontal”, “end”, “length”, “outer end”, “left”, “right”, etc. is based on the orientation or positional relationship shown in the figures, and is only for the convenience of describing the present invention and simplifying the description, rather than indicating or implying that the indicated device or element must have the particular orientation, construction and operation in the particular orientation, therefore, it cannot be construed as limitations of the present invention. The terms “first”, “second” are used for brevity of description only, and do not indicate or imply relative importance.

1. A hinge having both friction rotation shaft and automatic pop-open function, comprising a left-side rotating connection member, a right-side rotating connection member, and a plurality of matched rotation friction matching pieces and a plurality of fixed friction matching pieces, wherein the rotation friction matching pieces comprise a plurality of left-side rotation friction matching pieces and a plurality of right-side rotation friction matching pieces, the left-side rotation friction matching pieces are slidably connected to the left-side rotating connection member such that the left-side rotation friction matching pieces rotate synchronously with the left-side rotating connection member but can slide axially relative to the left-side rotating connection member, the right-side rotation friction matching pieces are slidably connected to the right-side rotating connection member such that the right-side rotation friction matching pieces rotate synchronously with the right-side rotating connection member but can slide axially relative to the right-side rotating connection member;
the hinge is provided with clutch cams, pop-open cams, a clutch member, and a spring assembly, both the pop-open cams and the clutch cams comprise static cams and rotating cams, the rotating cams can rotate relative to the static cams, wherein the rotating cams of the pop-open cams are connected to the left-side rotating connection member or the right-side rotating connection member, the rotating cams of the pop-open cams are slidably connected to the left-side rotating connection member or the right-side rotating connection member, and rotate synchronously with the connected left-side rotating connection member or right-side rotating connection member but can be displaced axially relative thereto; the hinge has a first working state and a second working state in the rotation stroke of the left-side rotating connection member and the right-side rotating connection member; in the first working state, the spring assembly provides a high rotational torque by pressing the matching of clutch cams through the clutch member and the clutch cams and pressing the friction matching between left-side rotation friction matching pieces and fixed friction matching pieces and between the right-side rotation friction matching pieces and the fixed friction matching pieces; in the second working state, the clutch member is disengaged from the spring assembly, the spring assembly maintains an axial pressing force on the left-side rotating connection member and the right-side rotating connection member, the rotation friction matching pieces and the fixed friction matching pieces are loosened, the rotating cams and the static cams of the pop-open cams realize an automatic rotation function by means of the pressing of the spring assembly and the control of the pop-open cams;
the clutch cams control the clutch member, in the first working state, the clutch cams enter a high-position matching, so that the clutch member moves axially forward and then axially abuts against the spring assembly, the spring assembly presses the clutch cams and the rotation friction matching pieces and the fixed friction matching pieces through the clutch member; in the second working state, clutch cams enter a low-position matching, so that there is a gap between the clutch member and the spring assembly in the axial direction, and the rotation friction matching pieces and the fixed friction matching pieces are loosened.

2. The hinge having both friction rotation shaft and automatic pop-open functions according to claim 1, wherein the hinge comprises a left-side rotating connection member shaft and a right-side rotating connection member shaft in parallel, the left-side rotating connection member shaft passes through the left-side rotation friction matching pieces and left sides of the fixed friction matching pieces, the right-side rotating connection member shaft passes through the right-side rotation friction matching pieces and right sides of the fixed friction matching pieces;
the clutch cams are located between the rotation friction matching pieces and the spring assembly; the clutch cams comprise left-side clutch cams and right-side clutch cams, the rotating cams of the left-side clutch cams are slidably connected to the left-side rotating connection member, the rotating cams of the right-side clutch cams are slidably connected to the right-side rotating connection member, the left-side rotating connection member shaft and the right-side rotating connection member shaft pass through the left-side clutch cams and the right-side clutch cams respectively, the static cams of the left-side clutch cams and right-side clutch cams are connected together;
the pop-open cams are located on the other side of the rotation friction matching pieces, and the pop-open cams comprise the left-side pop-open cams and right-side pop-open cams, the rotating cams of the left-side pop-open cams are connected to the left-side rotating connection member, the rotating cams of the right-side pop-open cams are connected to the right-side rotating connection member, the left-side rotating connection member shaft and the right-side rotating connection member shaft pass through the left-side pop-open cams and the right-side pop-open cams respectively, and the static cams of the left-side pop-open cams and the right-side pop-open cams are connected together.

3. The hinge having both friction rotation shaft and automatic pop-open functions according to claim 1, wherein the clutch member is connected to static cams of the clutch cams, the static cams of the clutch cams cannot rotate but can be axially displaced.

4. The hinge having both friction rotation shaft and automatic pop-open functions according to claim 1, wherein rotation friction matching pieces are also provided on the back of the rotating cams of the clutch cams.

5. The hinge having both friction rotation shaft and automatic pop-open functions according to claim 1, wherein the pop-open cams have a descending matching from a high-position matching to a low-position matching in the second working state, and a high-position platform matching in the first working state.

6. The hinge having both friction rotation shaft and automatic pop-open functions according to claim 1, wherein the left-side rotating connection member and the right-side rotating connection member are connected by a synchronous reverse rotating connection member to rotate synchronously and reversely; the left-side rotation friction matching pieces and the right-side rotation friction matching pieces are also connected to the left-side rotating member and the right-side rotating member of the synchronous reverse rotating connection mechanism.

7. The hinge having both friction rotation shaft and automatic pop-open functions according to claim 1, wherein the spring assembly is axially adjacent to the left-side rotating connection member and the right-side rotating connection member, and in the second working state, directly acts on the left-side rotating connection member and the right-side rotating connection member.

8. The hinge having both friction rotation shaft and automatic pop-open functions according to claim 1, wherein the spring assembly comprises a plurality of springs, a spring base and a spring bracket that can move forward and backward, the plurality of springs are located between the spring base and the spring bracket, both the left-side rotating connection member shaft and the right-side rotating connection member shaft pass through the spring base and the spring bracket, and the clutch member abuts against the spring bracket.

9. The hinge having both friction rotation shaft and automatic pop-open functions according to claim 1, wherein the left-side rotation friction matching pieces, the right-side rotation friction matching pieces and the rotating cams of the clutch cams are respectively provided with a handle portion, and are slidably clamped on the left-side rotating connection member or the right-side rotating connection member through the handle portion.

10. The hinge having both friction rotation shaft and automatic pop-open functions according to claim 1, wherein the hinge is a hinge of a mobile terminal.

11. The hinge having both friction rotation shaft and automatic pop-open functions according to claim 1, wherein the hinge is a hinge of an inward-folding flexible screen mobile terminal.

12. The hinge having both friction rotation shaft and automatic pop-open functions according to claim 1, wherein the second working state corresponds to a rotation angle range of a mobile terminal from nearly unfolding and flattening to unfolding and flattening.
